(19) United States
(12) Patent Application Publication
(10) Pub. No.: US 2013/0040099 A1
(43) Pub. Date: Feb. 14, 2013

(54) DISPOSABLE FLOOR MAT

(71) Applicant: Karen D. Prewett, Pismo Beach, CA (US)

(72) Inventor: Karen D. Prewett, Pismo Beach, CA (US)

(21) Appl. No.: 13/570,339

(22) Filed: Aug. 9, 2012

Related U.S. Application Data
(60) Provisional application No. 61/574,710, filed on Aug. 9, 2011.

(51) Int. Cl. B32B 3/08; B65B 1/04; B32B 3/02

(52) U.S. Cl. 428/119; 428/195.1; 428/192; 53/473

(57) ABSTRACT

A disposable floor mat comprises an upper surface for placement of feet of a user and a lower surface for placement of the mat on a floor of a bathroom. The mat also includes at least one tab coupled to the upper surface and adapted to permit a user to lift the floor mat off the floor by pulling the at least one tab in a direction away from the floor.

This application claims the benefit of U.S. Provisional Application No. 61/574,710, filed Aug. 9, 2011, which is incorporated in its entirety herein by reference.

### FIELD

This invention relates to floor mats, and more particularly, to disposable floor mats for placement on a bathroom floor.

### BACKGROUND

Public bathrooms commonly have dirty and wet floors due to street dirt, urine, and other substances. When sitting on a toilet a user typically lowers his or her pants to approximately knee level such that the pants often come into contact with the floor. It is not desirable for users, when using toilets, to soil their pants with the substances that may be present on the bathroom floor. Padding and mats are known to be placed near a toilet and under the user's feet to prevent the pants from directly contacting the bathroom floor.

Such mats can include a water absorbent layer to prevent the wetness on the floor from penetrating the mat and soiling the user's pants. Waxy or rubber materials can be included in the water absorbent layer. Examples of such mats include those described in U.S. Pat. No. 6,295,658 and U.S. Publication Nos. 2005/0223488 and 2008/0034485. One problem with such mats is that the mats are usually thin and flat, and are difficult to lift off the bathroom floor without the user inadvertently contacting the floor with his or her fingers and/or hand. To avoid this problem, some mats, for example, a mat described in U.S. Pat. No. 6,787,210, include an additional structure (i.e., a ring) and an additional device (i.e., a hooking device) that the user can use to hook and lift the mat off the floor without placing the user's hands in contact with the floor.

Accordingly, what is needed is a disposable mat that can effectively prevent the wetness present on bathroom floors from soiling the user's pants when the user is on a toilet, and that can be lifted off the floor quickly without an extraneous device and without allowing the user's fingers to come into proximity and possible contact with the bathroom floor.

### SUMMARY

The present invention satisfies this need. In a preferred embodiment, a disposable floor mat is provided. The floor mat includes an upper surface for placement of feet of a user; a lower surface for placement of the mat on a floor of a bathroom; and at least one tab coupled to the upper surface and adapted to permit a user to lift the floor mat off the floor by pulling the at least one tab in a direction away from the floor.

The upper surface of the mat can be water permeable and the lower surface of the mat can be water impermeable. The lower surface of the mat can alternatively be water absorbent.

The at least one tab can at least in part overlie the upper surface of the mat such that the upper surface of the mat is positioned between the at least one tab and the floor.

The lower surface of the mat can include one of a coating and an attached material selected from one of waxy paper, wax, fabric material, rubber material, and plastic material.

The at least one tab can be positioned at an angle of between 90 and 45 degrees relative to the upper surface of the mat.

The at least one tab can have a base attached to the upper surface of the mat. The at least one tab can be adapted to pivot about the base in a direction away from the upper surface of the mat to a position where the tab is substantially perpendicular to the upper surface of the mat. The at least one tab can also be adapted to pivot about the base in a direction toward the upper surface of the mat to a position where the tab is substantially in contact with and parallel to the upper surface of the mat.

In one approach, the at least one tab and the upper surface of the mat are made from a material that is identical. In another approach, the at least one tab and the upper surface of the mat are made from distinct materials.

In a preferred embodiment, the mat has a front edge, a rear edge, first and second side edges connecting the front and rear edges, and at least one tab being positioned proximate the intersection of the front edge and the first side edge. In one approach, at least a second tab is positioned proximate the intersection of the rear edge and the second side edge. The rear edge of the mat can include an indentation adapted to match a shape of a front of a base of a toilet.

The mat can have a first maximum dimension from the front edge to the rear edge in a direction parallel to the first and second side edges and a second maximum dimension from the first side edge to the second side edge in a direction parallel to the front and rear edges, the second maximum dimension being greater than the first maximum dimension.

The mat can have a perimeter that is rectangular such that the front and rear edges are entirely parallel to each other and the first and second side edges are entirely parallel to each other.

In one approach, the upper surface of the mat can include printed indicia to indicate to a user that the user's feet are to be placed on the upper surface of the mat. The mat can also be made of a biodegradable material.

A method of using the disposable mat described above. The method includes placing the lower surface of the mat on the floor of the bathroom; grasping the at least one tab; lifting the mat in a direction away from the floor by pulling the at least one tab in an upward direction; and disposing the mat in one of a trash bin and toilet bowl.

In another preferred embodiment, a disposable floor mat can include a water impermeable layer and at least one pull tab attached to an upper surface of the disposable floor mat and adapted to permit a user to lift the floor mat off the floor by pulling the at least one pull tab in a direction away from the floor.

In yet another preferred embodiment, a disposable floor mat includes waxy paper and at least one pull tab attached to an upper surface of the disposable floor mat and adapted to permit a user to lift the floor mat off the floor by pulling the at least one pull tab in a direction away from the floor.

The disposable mat described in the present application provides numerous advantages over the presently used disposable mats. One advantage is that the mat includes a pull tab that can be used to lift the mat off the bathroom floor without any part of the user's hand coming into contact with the bathroom floor. Another advantage is that the mat has an undersurface that is water absorbent and/or water impermeable and prevents the upper surface of the mat and the pull tab, as well as the user's fingers and/or hand, from becoming soiled with wetness typically present on bathroom floors. Yet another advantage is that the mat is disposable and biodegradable and can be disposed by the user into a trash can or a toilet. Further advantages will be appreciated by those of ordinary skill in the art with reference to the following drawings, detailed description, and claims.

### BRIEF DESCRIPTION OF THE DRAWINGS

FIG. 1 is a front perspective view of one embodiment of the disposable mat placed at a base of a toilet seat.

FIG. 2 is a perspective view of another embodiment of the disposable mat placed at the base of a toilet seat with a portion of the mat broken away to show the structure of the mat.

FIG. 3 is a close-up perspective view of a corner of the disposable mat according to an embodiment of the present invention being lifted by a user via the pull tab.

FIG. 4 is a perspective view of an embodiment of the disposable mat being folded.

### DETAILED DESCRIPTION

Reference will now be made in detail to the present preferred embodiments of the invention, examples of which are illustrated in the accompanying drawings.

Generally, a mat for placement on bathroom floors proximate a toilet seat is described. The mat is made of a disposable and/or biodegradable material and includes a layer that is water absorbent and/or water impermeable. The mat includes one or more pull tabs attached to its upper surface. The pull tabs can be used to lift the mat off the bathroom floor to be disposed in a trash can or a toilet bowl. Since the pull tabs extend away from the upper surface of the mat, the upper surface of the mat underlies the pull tabs and prevents the user's fingers and/or hand from coming into contact with the bathroom floor when the user lifts,the mat off the bathroom floor using the pull tabs.

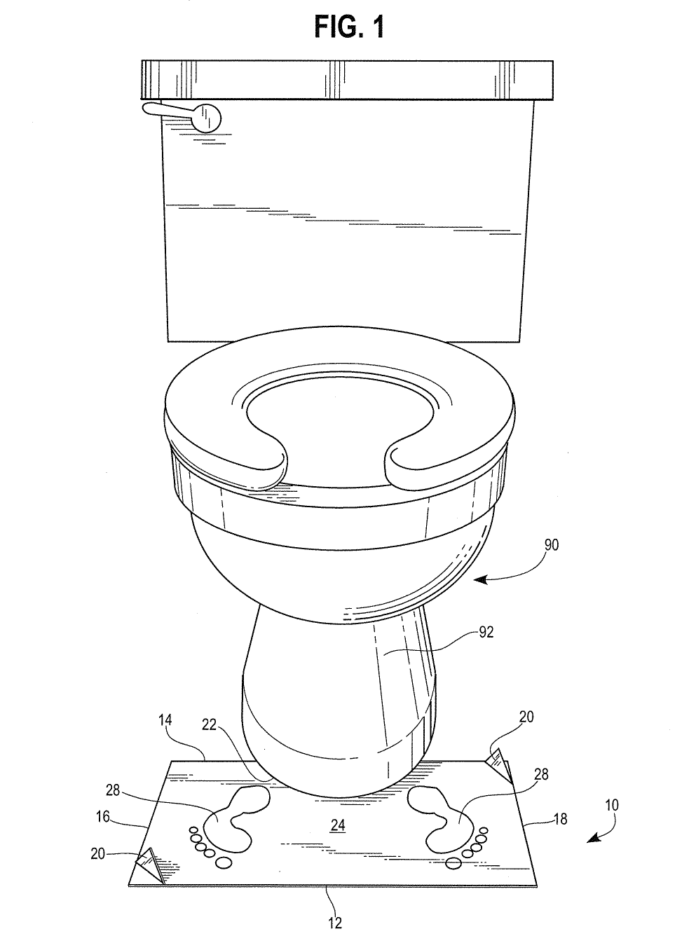

Referring to FIG. 1, a floor mat 10 according to a preferred embodiment of the present invention is shown at the base 92 of a toilet 90. The floor mat is generally rectangular, but it will be appreciated that the mat 10 can be of any suitable shape, including, but not limited to, circular, oval, square, trapezoidal, and triangular. The mat 10 has a front edge 12, a rear edge 14 opposite the front edge 12, a first side edge 16, and a second side edge 18 opposite the first side edge 16. The first and second side edges 16, 18 connect the front and rear edges 12, 14. The mat also 10 includes one or more devices, for example, pull tabs 20 as shown in FIG. 1, for facilitating a user to lift the mat 10 off the bathroom floor.

As shown in FIG. 1, the mat 10 can include a cutout or indent 22 that preferably matches the shape of the base 92 of the toilet 90 and allows the mat 10 to be brought into contact with a front face of the base 92 of the toilet 90 such that the cutout 22 at least in part surrounds the front face of the base 92 of the toilet 90.

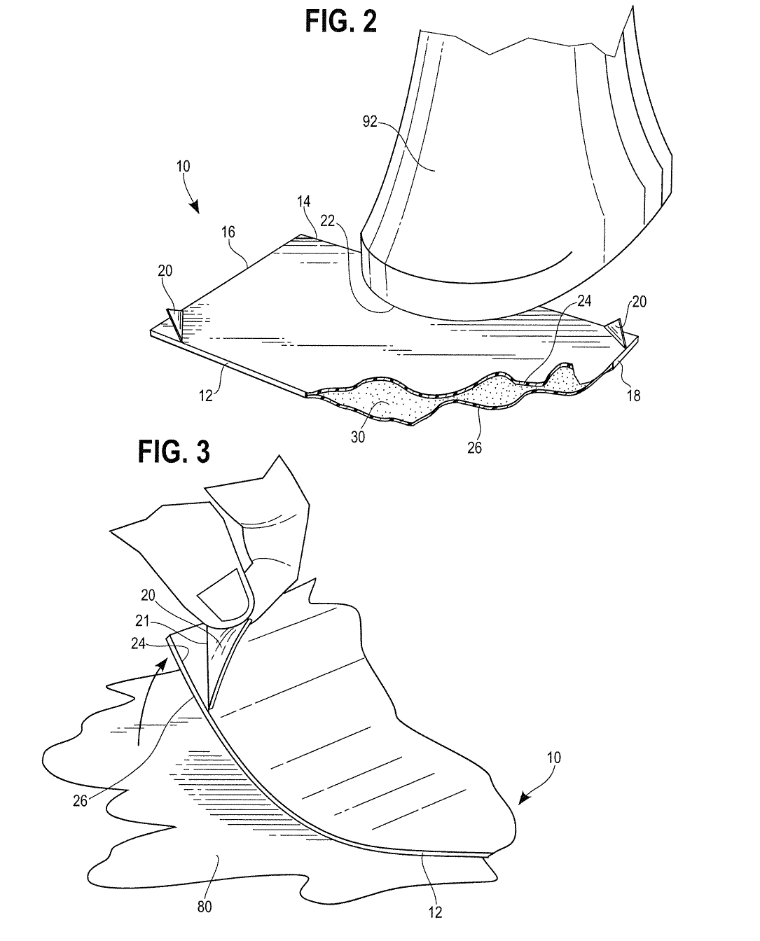

Referring to FIGS. 1 and 2, the mat 10 has a maximum dimension from the front edge 12 to the rear edge 14 in a direction parallel to the first and second side edges 16 and 18 that is less than the maximum distance from the first side edge 16 to the second side edge 18 in a direction parallel to the front and rear edges 12 and 14. Alternatively, the mat 10 can be made such that the maximum distance from the first side edge 16 to the second side edge 18 in a direction parallel to the front and rear edges 12 and 14 is less than the maximum dimension from the front edge 12 to the rear edge 14 in a direction parallel to the first and second side edges 16 and 18.

It is to be appreciated that the mat 10 can be made without the cutout 22. In such a case, the perimeter of the mat 10 would be rectangular, the front and rear edges 12 and 14 could be parallel to each other in their entirety, and the first and second side edges 16 and 18 would be parallel to each other in their entirety. It is to be appreciated that the mat 10 can be made such that the front and rear edges 12 and 14 are parallel to each other only in part or not parallel at all. Similarly, the mat 10 can be made such that the first and second side edges 16 and 18 are parallel to each other only in part or not parallel at all. The mat 10, when made without the cutout 22, can be placed in front of and proximate the base 92 of the toilet 90 to be used according to the principles of this invention.

Referring to FIGS. 1 and 2, the mat 10 includes a lower surface 26 which is to be placed on the bathroom floor and an upper surface 24 which is to be placed facing up such that the user can place his or her feet directly on the upper surface 24. As shown in FIG. 1, the upper surface 24 of the mat 10 can include printed indicia 28 such as pictures of feet to indicate to a user that the upper surface 24 is to be placed facing up. It is to be appreciated that mat 10 can include any other printed indicia 28 other than feet, for example, arrows, dots, or the like, or printed words such as “THIS SIDE UP,” “PLACE FEET HERE,” or the like. It is to be appreciated that the mat 10 may entirely omit printed indicia 28, as shown in FIG. 2. Without the printed indicia 28, the user may understand which side is to be placed on the bathroom floor by recognizing the textural differences between the upper surface 24 and the lower surface 26, which will be described in more detail below.

With reference to FIG. 2, the upper surface 24 of the mat 10 can be made of a material that is water permeable. For example, the upper surface 24 of the mat 10 can be made of paper. The lower surface 26 of the mat 10 preferably includes a coating of material 30 that is water absorbent and/or water impermeable. The material 30 can be attached to the lower surface 26 of the mat 10 by an adhesive, or any other suitable known technique, for example fusion, or may be directly incorporated into the structure of the mat 10.

The material 30 can be one material, or a blend of materials including, but not limited to, waxy paper, paraffin wax, fabric materials, rubber materials, and plastic materials. Preferably, but not necessarily, the mat 10 is made entirely of materials that are biodegradable and could be safely disposed of both in a trash bin and toilet bowl. The presence of the material 30 preferably makes the lower surface 26 of the mat 10 impermeable to water such that the mat 10 is waterproof. This allows the mat to prevent the water, urine/and or dirt on the bathroom floor from passing through the mat 10, thereby protecting the user's pants and shoes from being soiled by such water, urine, and/or dirt. The presence of the material 30 can also add friction to the lower surface 26 of the mat 10 such that the mat 10 is slip-resistant when placed on the bathroom floor. It is to be appreciated that the mat 10 can be made slip-resistant by including a sticky or slip-resistant material in addition to the material 30. It is also to be appreciated that the upper and lower surfaces 24 and 26 of the mat 10 may have slightly different texture due to the presence of the material 30 on the lower surface 26, thereby permitting the user to recognize which side of the mat 10 goes on the floor, and which side is to face upward for placement of the user's feet.

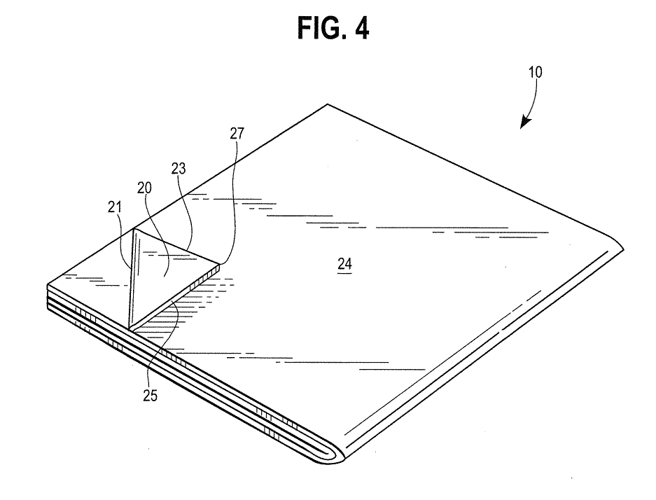

With reference to FIGS. 1 and 4, the pull tab 20 of the mat 10 will be now described in more detail. As shown in FIG. 1, the mat 10 includes two pull tabs 20 positioned in opposite corners of the mat 10. In particular, a first tab 20 is positioned proximate the intersection of the front edge 12 and the first side edge 16, while a second tab is positioned proximate the intersection of the rear edge 14 and the second side edge 18. It is to be appreciated that the mat 10 can have just one pull tab 20, can have four pull tabs 20 such that a pull tab 20 is present in every corner of the mat 10, or can have three pulls tabs 20 such that not every corner of the mat 10 has a pull tab. It is also to be appreciated that for non-rectangular mats, any suitable number of pull tables 20 may be provided to facilitate the user in lifting the mat off the floor. For example, a mat could have 5, 6, or more pull tables 20, where appropriate, to accommodate the shape of the mat. Further, it is to be appreciated that the mat 10 can have one more pull tabs where none of the pull tabs 20 are proximate a corner of the mat 10.

With reference to FIG. 4, the exemplary pull tab 20 is triangular and has a base 21, a first side 23, a second side 25, and an apex 27. It is to be appreciated that while the pull tab 20 has been illustrated as triangular, the pull tab may be in the form of a rectangle, square, circle, oval, strip, or any other suitable regular or irregular shape (e.g., a hook-shaped, key-shaped, or tongue-shaped) that permits the user to grasp the pull tab 20 with his or her fingers. It is also to be appreciated that the pull tab 20, instead of being a unitary structure, may be in the form of two distinct structures, for example, two strips.

The pull tab 20 is attached to the upper surface 24 of the mat 10 via an adhesive, fusion, or any other suitable attachment techniques. In one approach, the pull tab 20 can be made from the same material as the upper surface 24 of the mat 10, for example, of paper. In another approach, the pull tab 20 can be made from a material that is different from the material comprising the upper surface 24 of the mat 10. By way of example only, the pull tab 20 can be made from one material or a blend of materials including plastic, rubber, polymer, or the like.

As shown in FIG. 3, the pull tab 20 is pivotally attached to the upper surface 24 of the mat 10 such that the pull tab 20 is permitted to move about the base 21 both in a direction away from the upper surface 24 of the mat 10 to a position where the pull tab 20 is substantially perpendicular to the upper surface 24 of the mat 10, and in a direction toward the upper surface 24 of the mat 10 to a position where the pull tab 20 is substantially in contact with and parallel to the upper surface 24 of the mat 10. For example, the pull tab 20 can be in a position substantially perpendicular to the upper surface 24 of the mat 10 when grasped by the user's fingers during the lifting of the mat 10 off the bathroom floor, as shown in FIG. 3. As another example, the pull tab 20 can be in a position where it is substantially parallel and fully in contact with the upper surface 24 of the mat 10 when the mat 10 is in a folded configuration suitable for packaging, as shown in FIG. 4.

It is also to be appreciated that the pull tab 20 does not have to be in a position substantially perpendicular to the upper surface 24 of the mat when grasped by the fingers of a user, or substantially parallel to the upper surface 24 of the mat 10 when not grasped by the user. The pull tab 20 can travel in a range of motion of approximately 180 degrees relative to the upper surface 24 of the mat 10 and can be at any angle in the 0 to 180 degree range relative to the upper surface 24 of the mat 10 when the mat 10 is in use or not in use. By way of example only, the pull tab 20 can be positioned between 90 and 45 degrees relative to the upper surface 24 of the mat 10 when grasped by the user for pulling the mat 10 off the bathroom floor 80.

As shown in FIGS. 3 and 4, the pull tab 20 overlies the upper surface 24 of the mat 10 such that the upper surface 24 of the mat 10 is positioned between the pull tab 20 and the bathroom floor 80 and, advantageously, between the user's fingers, and the bathroom floor 80, thereby protecting the user's fingers from coming into contact with the dirty and/or soiled floor 80 when grasping the pull tab 20 of the mat 10.

By way of example only, the mat can have a length from front edge 12 to rear edge of 24 inches and a width from the first side edge 16 to the second edge 18 of 36 inches. It is to be appreciated that the mat 10 can have a variety of shapes and sizes to accommodate toilets of all sizes and users of all ages and sizes. For example, the mat can be as small as 12 inches in length and 24 inches in width, or 12 inches in both length and width.

A method of using the disposable mat 10 described above is also provided. The mat 10 can be provided to a user in a package including two or more of the mats 10 folded substantially as shown in FIG. 4. Such packaging can have three, four, five, six, or more mats 10. It is to be appreciated that the mats 10 can also be provided to a user in a dispenser located in the bathroom, and more specifically, in close proximity to the toilet 90.

In use, a user can remove the mat 10 from the packaging or a dispenser, as appropriate, and unfold the mat 10 from the folded orientation shown in FIG. 4 to an unfolded orientation shown in FIG. 1. The user can then place the mat 10 on the bathroom floor as shown substantially in FIG. 1 and place his or her feet on the mat 10, for example, on the printed indicia 28 on the upper surface 24 of the mat 10. It is to be appreciated that the position of the mat 10 relative to the base 92 of the toilet 90 is shown by way of example only, and that the mat 10, even in a configuration including the cutout 22 is present, does not necessarily have to be in contact with the front face of the base 92 of the toilet 90.

During the use of the toilet with the mat 10 in the exemplary position shown in FIG. 1, the user's pants and shoes can rest on the upper surface 24 of the mat 10, and the material 30 of the mat 10 ensures that no wetness present on the bathroom floor penetrates the mat 10 to soil the user's pants or shoes. When the user is finished using the toilet 90, the user can dispose of the mat 10 by grasping the pull tab 20 of the mat 10 and lifting the pull tab 20 in a direction away from the upper surface 24 of the mat 10, as shown, for example, in FIG. 3.

It is to be appreciated that the user can grasp either one or both of the pull tabs 20 shown in FIG. 1 to lift the mat 10 off the floor 80. As discussed above, the upper surface 24 is present on both sides of the pull tab 20 and protects the user's fingers front coming into contact with the bathroom floor 80. Once the user lifts the mat 10 off the floor, the user can dispose of the mat by throwing the mat 10 into a trash can, or into the toilet 90, as appropriate. The next user can then use his or her own mat 10, which the user can remove from packaging or a bathroom dispenser.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

What is claimed is:

1. A disposable floor mat comprising:
an upper surface for placement of feet of a user;
a lower surface for placement of the mat on a floor of a bathroom; and
at least one tab coupled to the upper surface and adapted to permit a user to lift the floor mat off the floor by pulling the at least one tab in a direction away from the floor.

2. The mat of claim 1, wherein the upper surface of the mat is water permeable and the lower surface of the mat is one of water impermeable and water absorbent.

3. The mat of claim 1, wherein the lower surface of the mat includes one of a coating and an attached material selected from selected from one of waxy paper, wax, fabric material, rubber material, and plastic material.

4. The mat of claim 1, wherein the at least one tab at least in part overlies the upper surface of the mat such that the upper surface is positioned between the at least one tab and the floor.

5. The mat of claim 1, wherein the at least one tab is positioned at an angle of between 90 and 45 degrees relative to the upper surface of the mat.

6. The mat of claim 1, wherein the at least one tab has a base attached to the upper surface of the mat.

7. The mat of claim 6, wherein the at least one tab is adapted to pivot about the base in a direction away from the upper surface of the mat to a position where the tab is substantially perpendicular to the upper surface of the mat.

8. The mat of claim 6, wherein the at least one tab is adapted to pivot about the base in a direction toward the upper surface of the mat to a position where the tab is substantially in contact with and parallel to the upper surface of the mat.

9. The mat of claim 1, wherein the at least one tab and the upper surface of the mat are made from a material that is identical.

10. The mat of claim 1, wherein the at least one tab and the upper surface of the mat are made from at least one distinct material.

11. The mat of claim 1, wherein the mat has a front edge, a rear edge, and first and second side edges connecting the front and rear edges, the at least one tab being positioned proximate the intersection of the front edge and the first side edge.

12. The mat of claim 11, wherein the mat has a first maximum dimension from the front edge to the rear edge in a direction parallel to the first and second side edges and a second maximum dimension from the first side edge to the second side edge in a direction from parallel to the front and rear edges, the second maximum dimension being greater than the first maximum dimension.

13. The mat of claim 11, wherein at least a second tab is positioned proximate the intersection of the rear edge and the second side edge.

14. The mat of claim 11, wherein the rear edge of the mat includes an indentation adapted to match a shape of a front of a base of a toilet.

15. The mat of claim 1, wherein the mat has a perimeter that is rectangular such that the front and rear edges are entirely parallel to each other and the first and second side edges are entirely parallel to each other.

16. The mat of claim 1, wherein the upper surface of the mat includes printed indicia to indicate to a user that the user's feet are to be placed on the upper surface of the mat.

17. The mat of claim 1, wherein the mat is made entirely of a biodegradable material.

18. A method of using the disposable mat of claim 1, the method comprising:
placing the lower surface of the mat on the floor of the bathroom;
grasping the at least one tab;
lifting the mat in a direction away from the floor by pulling the at least one tab in an upward direction away from the floor; and
disposing the mat in one of a trash bin and toilet bowl.

19. A disposable floor mat comprising a water impermeable layer and at least one pull tab attached to an upper surface of the disposable floor mat and adapted to permit a user to lift the floor mat off the floor by pulling the at least one pull tab in a direction away from the floor.

20. A disposable paper floor mat comprising waxy paper and at least one pull tab attached to an upper surface of the disposable floor mat and adapted to permit a user to lift the floor mat off the floor by pulling the at least one pull tab in a direction away from the floor.
